(19) United States
(12) Patent Application Publication
(10) Pub. No.: US 2017/0088351 A1
(43) Pub. Date: Mar. 30, 2017

(54) BLOW MOLDED WASTE CART WITH INSERT MOLDED LIFT POCKET REINFORCEMENT

(71) Applicants: Bruce Hamilton, Jefferson, OH (US); Brian Moroney, Mentor, OH (US); Douglas Eck, Colwich, KS (US)

(72) Inventors: Bruce Hamilton, Jefferson, OH (US); Brian Moroney, Mentor, OH (US); Douglas Eck, Colwich, KS (US)

(73) Assignee: Toledo Molding & Die, Inc., Toledo, OH (US)

(21) Appl. No.: 15/172,621

(22) Filed: Jun. 3, 2016

Related U.S. Application Data
(60) Provisional application No. 62/170,506, filed on Jun. 3, 2015.

(51) Int. Cl. B65F 1/14; B29B 11/06; B29C 49/20; B65F 1/02

(52) U.S. Cl. CPC B65F 1/1452; B65F 1/02; B65F 1/1473; B29B 11/06; B29C 49/20; B65F 2250/114; B29L 2031/712

(57) ABSTRACT

A body for a blow molded waste cart and a waste cart having a blow-molded hollow body having a front wall and a central channel formed in the front wall, a lift pocket formed in the central channel, and a lift pocket reinforcement insert molded into the lift pocket. The lift pocket reinforcement has a main body formed with a longitudinal axis, an upper face, a rear face including a generally planar lift contact surface and a plurality of retention keys that retain the polymer of the parison after molding. The retention keys may be undercut to improve retention of the polymer. The lift pocket reinforcement may be blow-molded and the retention keys may be in the shape of a section of a trapezoidal cone.

### TECHNICAL FIELD AND INDUSTRIAL APPLICABILITY OF THE INVENTION

The present invention relates to blow molded waste carts, also referred to as wheeled trashcans, which are substantially constructed of blow-molded polymeric materials. The present invention related specifically to a blow molded lift pocket with an insert-molded reinforcement. The insert molded retention pocket reinforcement strengthens the lift pocket without the use of mechanical fasteners or adhesives. A blow molded waste cart that is assembled without the use of mechanical fasteners or adhesives provides a sturdier cart with reduced assembly cost and improved durability.

### BACKGROUND OF THE INVENTION

Blow molding is used to produce generally hollow plastic parts by melting plastic infeed material, forming a parison (a tubular piece of plastic), placing the parison into a mold and blowing air into the parison to force the plastic out to match the mold. The plastic cools and hardens within the mold and the mold is opened the part is ejected. The main bodies of waste carts have been made by the blow molding process for many years, however previous blow molded waste carts required a substantial number of additional mechanically attached parts. The use of mechanical attachments increases the cost of manufacture while increasing the number of potential failure points while in use.

### SUMMARY OF THE INVENTION

The present invention relates to blow molded waste carts and more specifically to waste carts with an insert-molded reinforcement included in the lift pocket of the cart. The insert-molded reinforcement allows the reinforced lifting bar to be attached to the waste cart without the use of adhesives or mechanical attachments. The use of the insert-molded reinforcement allows the waste cart to be formed more quickly and economically and also provides a more rugged cart while in use. Specifically, a body for a blow molded waste cart and a waste cart having a blow-molded hollow body are disclosed. The blow-molded hollow body having a front wall and a central channel formed in the front wall, a lift pocket formed in the central channel, and a lift pocket reinforcement insert molded into the lift pocket. The lift pocket reinforcement has a main body formed with a longitudinal axis, an upper face, a rear face including a generally planar lift contact surface and a plurality of retention keys that retain the polymer of the parison after molding. The retention keys may be undercut to improve retention of the polymer. The lift pocket reinforcement may be blow-molded and the retention keys may be in the shape of a section of a trapezoidal cone.

### BRIEF DESCRIPTION OF THE DRAWING

A more complete appreciation of the invention and the many embodiments thereof will be readily obtained as the same becomes better understood by reference to the following detailed description when considered in connection with the accompanying drawings, wherein:

FIG. 1A illustrates a side view of a blow molded waste cart including an insert-molded reinforcement in the lift pocket in accordance with the present invention;

FIG. 1B illustrates a side view of a blow molded waste cart including an insert-molded reinforcement in the lift pocket in accordance with the present invention;

FIG. 2A illustrates a top view of a blow molded waste cart including an insert-molded reinforcement in the lift pocket in accordance with the present invention;

FIG. 2B illustrates a lower perspective view of a blow molded waste cart including an insert-molded reinforcement in the lift pocket in accordance with the present invention;

FIG. 3A illustrates an lower perspective view of a reinforcing insert suitable for use as an insert-molded reinforcement in the lift pocket in accordance with the present invention;

FIG. 3B illustrates a plan view of a reinforcing insert suitable for use as an insert-molded reinforcement in the lift pocket in accordance with the present invention; and

FIG. 3C illustrates a plan view of a reinforcing insert suitable for use as an insert-molded reinforcement in the lift pocket in accordance with the present invention; and

FIG. 3D illustrates a plan view in detail of a retention key of a reinforcing insert suitable for use as an insert-molded reinforcement in the lift pocket in accordance with the present invention.

### DETAILED DESCRIPTION AND PREFERRED EMBODIMENTS OF THE INVENTION

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

Unless otherwise indicated, all numbers expressing quantities of ingredients, properties such as molecular weight, reaction conditions, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

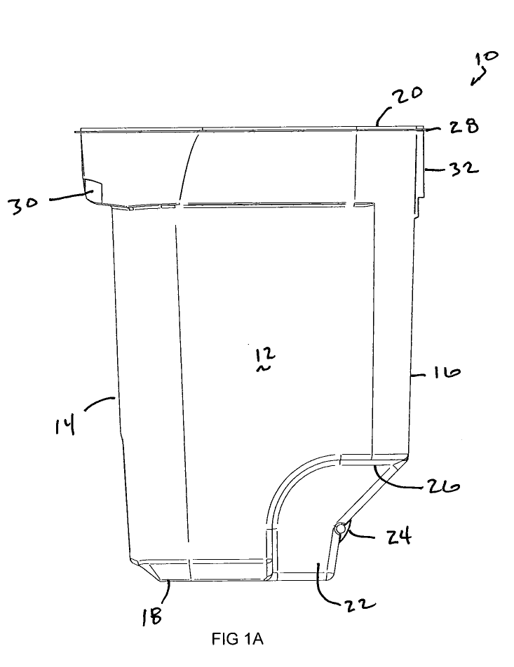

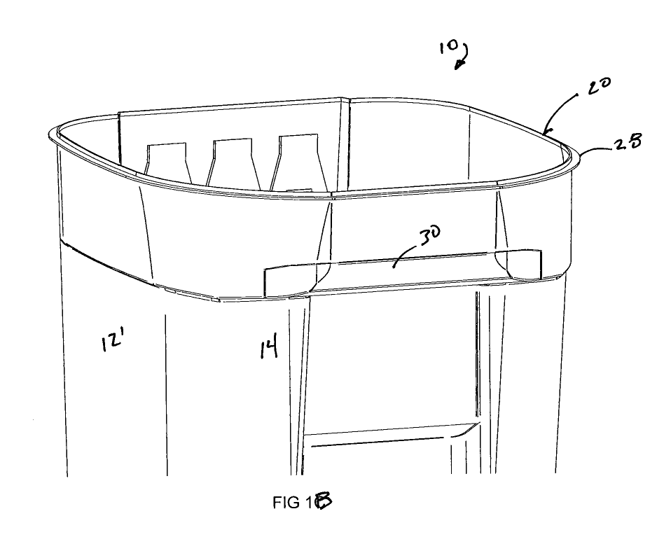

A blow molded waste cart is shown in FIG. 1. The cart 10 includes a hollow central body formed by front wall 14, rear wall 16, right wall 12, left wall 12′ and floor 18 such that waste may be received within the hollow central body. Cart body 10 includes cutouts 22 with fender sections 26 in sidewalls 12, 12′ for wheels (not shown) to be mounted on an axle retained by axle strap 24. Waste cart 10 may be tilted to roll on the wheels and returned to a vertical orientation to rest in a stable, vertical position. The top of waste cart 10 includes an upper rim 20 and may optionally include a reinforcing flange 28. Reinforced lift pocket 30 and handle insert 32 for a handle may also be included.

The blow-molded cart 10, including an insert-molded reinforcement 30 of the present invention is shown in FIG. 1B. The use of the insert-molded reinforcement allows the formation of a lift pocket 30 and also strengthens the lift pocket 30 of the waste cart 10 when lifted on a hydraulic arm or other lifting apparatus used by a truck to tip the contents of cart 10 into a truck. The insert-molded reinforcement 30 is inserted into the mold during the blow-molding process. The polymer of the parison for front wall 14 expands over reinforcement 30 and secures the reinforcement in the body of the waste cart without the use of mechanical fasteners or adhesives. Side wall 12′, top rim 20 and reinforcing rim 28 are also shown.

The waste cart 10 is formed in a blow molding manufacturing process. The blow molding process begins melting the polymer material and forming a forming it into a parison. The parison is a polymer sleeve that is clamped into a mold. The mold includes two halves, which are generally referred to as the pin half and the bushing half. The mold includes a shelf for receiving reinforcing beam 30. Reinforcing beam 30 is placed on the shelf and the pin half and bushing half are clamped around the parison. Air is then blown into the mold to force the parison against the mold and the reinforcing beam 30 to form the general shape of cart 10. Once the waste cart 10 is formed and the plastic has cooled somewhat the mold is opened and the waste can is ejected.

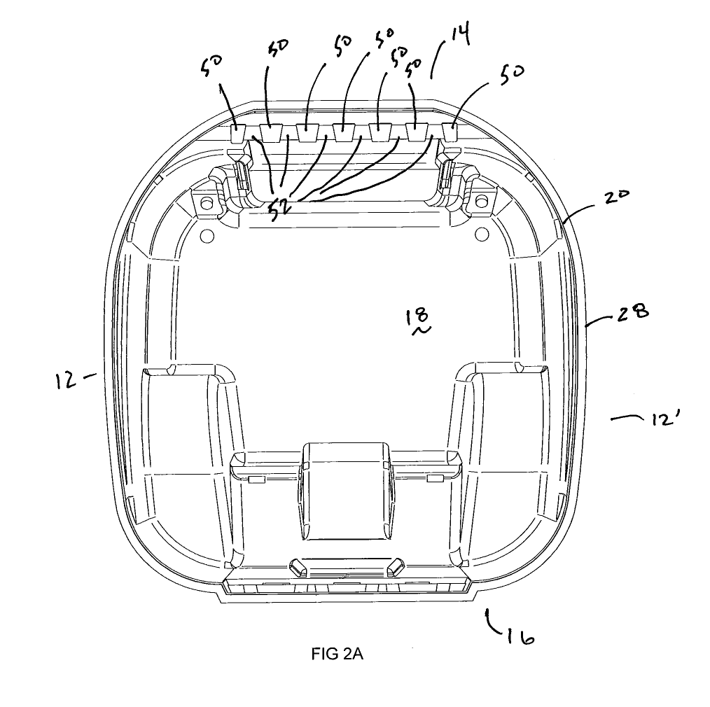

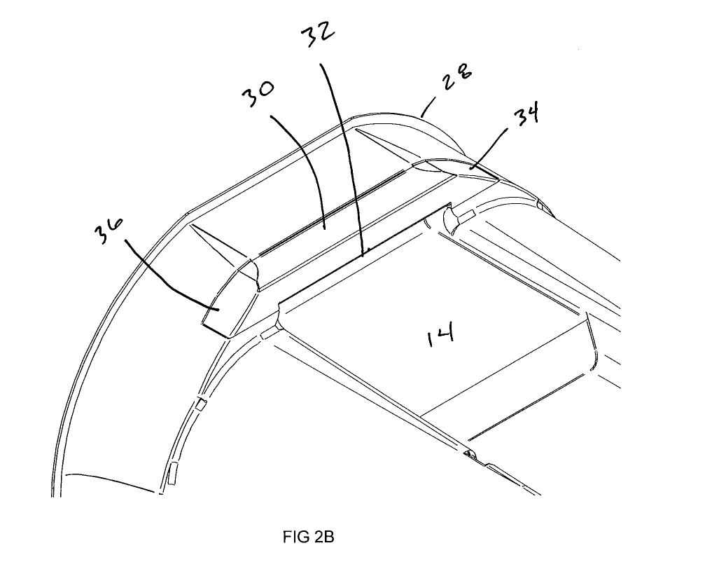

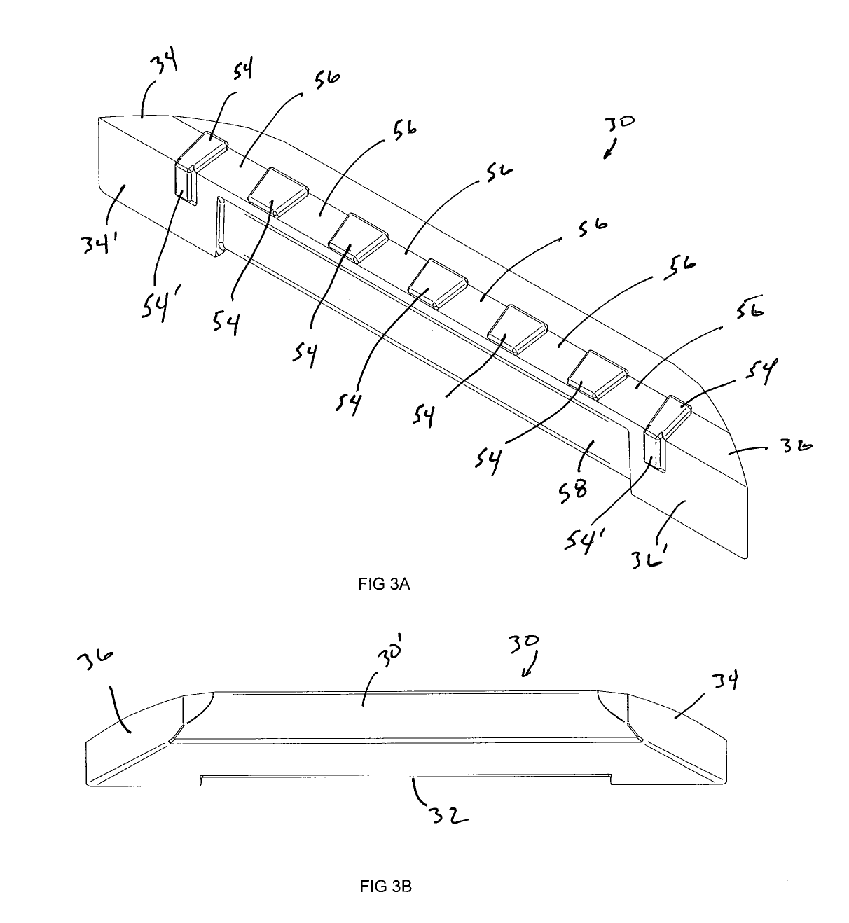

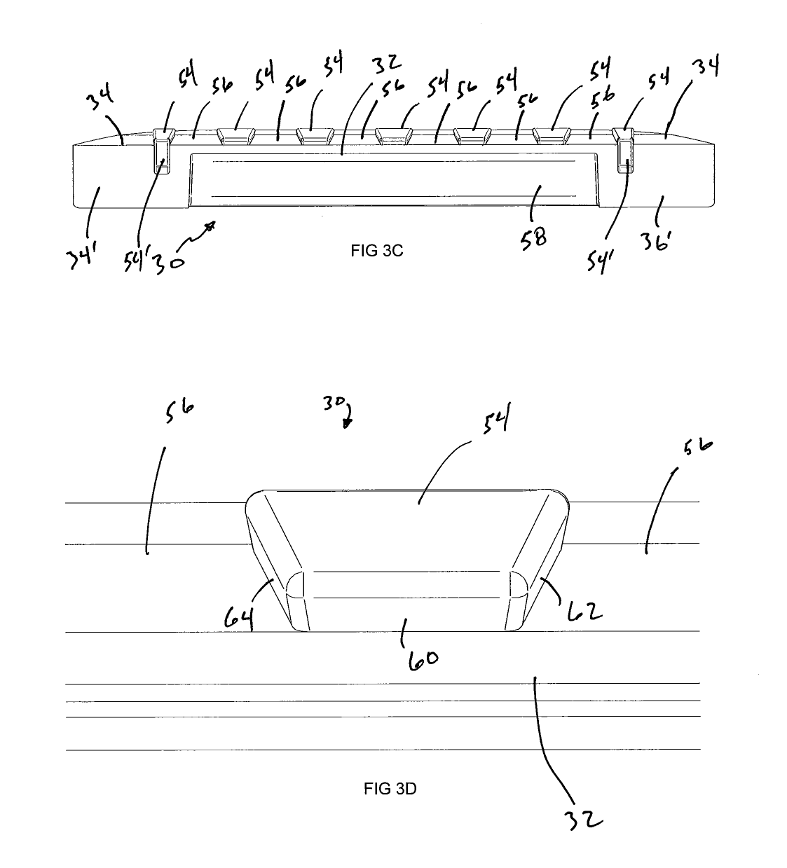

The blow-molded cart of the present invention, including an insert-molded reinforcement 30 is shown in FIG. 2A. Cart 10 includes base 18, sidewalls 12, 12′ rear wall 16 and front wall 14. The insert-molded reinforcement 30 strengthens the lift pocket of waste cart 10. The insert-molded reinforcement 30 is inserted into the mold during the blow-molding process. Reinforcement 30 include a number of keys 54 with sidewall 60, 62, 64, which form undercuts, and lands 56 (as shown in FIG. 3A, 3D). In the molding process, parison expands over the keys 54 and lands 56 and fills the section under the undercut formed by sidewalls 60, 62, 64 to form key sections 50 and land sections 52, such that the reinforcement 30 is firmly retained in the body of waste cart 10. Generally, the bond of the reinforcement 30 with the polymer of cart 10 is as strong as the body of waste cart 10 itself.

FIG. 2B shows the lift pocket 32 formed between the insert-molded reinforcement 30 and the front wall 14 of cart 10. Reinforcement 30 includes side sections 34, 36 that correspond to the contours of front wall 14 so that the front surface of the can presents a uniform surface. Reinforcement 30 strengthens the lift pocket such that a hydraulic arm of a waste truck may tip the cart into the truck without mechanical failure of front wall 14 over the life of waste cart 10.

The reinforcing insert 30 is shown in detail in FIG. 3A. The reinforcement may itself be formed by blow molding. Typically, reinforcement 30 has a longitudinal axis, a generally planar lift contact surface 58, which runs parallel to the longitudinal axis, a number of undercut retention keys 54 spaced along the upper surface and with a number of keys 54′ on the rear surfaces 34′, 36′ of reinforcement 30. The retention keys 54 define a number of lands 56 such that when polymer from the parison expands around keys 54 into lands 56, the front wall 14 of cart 10 is permanently fixed the reinforcement 10.

The outer face of the 30 is shown in FIG. 3B. The top face 30′ and beveled side faces 34, 36 generally match with the surfaces of cart body 10 to reduce wear and eliminate catch points on the surface. The lower face opens to the lift contact surface 32. The reinforcement 10 is generally blow molded from a heavy parison so that the reinforcement is rugged for long-term use in a high wear application, other molding operations such as injection molding, rotomolding and compression molding may also be suitable.

The rear face of reinforcement 30 is shown in FIG. 3C, in which the generally planar lift contact surface 58 is parallel to the longitudinal axis. Reinforcement 30 includes a number of undercut retention keys 54 spaced along the upper surface and with a number of keys 54′ on the rear surfaces 34′, 36′ of reinforcement 30. The retention keys 54 define a number of lands 56 such that when polymer from the parison expands around keys 54 into lands 56, the front wall 14 of cart 10 is permanently fixed the reinforcement 10.

An undercut retention key 54 of reinforcement 30 is shown in FIG. 3D. As can be seen, key 54 includes a generally trapezoidal top surface raised above the surface of the lands 56 by generally trapezoidal sidewalls 60, 62, 64 to form a section of a trapezoidal cone. Undercut sections are formed under sidewalls 60, 62, 64. The undercuts and generally trapezoidal shape of key 54 inhibit movement of reinforcement 30 in the polymer of waste cart 10 after the blow-molding process.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

We claim:

1. A blow molded waste cart, comprising:
a blow-molded hollow body having a front wall and a central channel formed in the front wall;
a floor, the body and floor form a waste receptacle;
a lift pocket formed in the central channel;
a lift pocket reinforcement insert molded into the lift pocket.

2. The blow molded waste cart of claim 1, where in the lift pocket reinforcement comprises:
a main body formed with a longitudinal axis,
an upper face;
a rear face including a generally planar lift contact surface; and
a plurality of retention keys.

3. The blow molded waste cart of claim 2, wherein the retention keys are spaced along the upper face.

4. The blow molded waste cart of claim 2, wherein a plurality of retention keys are formed on the rear face.

5. The blow molded waste cart of claim 2, wherein the retention keys are undercut.

6. The blow-molded waste cart of claim 1, wherein the lift pocket reinforcement is blow-molded.

7. The blow-molded waste cart of claim 1, wherein the retention key has a generally trapezoidal top surface.

8. The blow-molded waste cart of claim 7, wherein the retention key is a section of a trapezoidal cone.

9. A blow molded body for a waste cart, comprising:
a blow-molded hollow body having a front wall and a central channel formed in the front wall;
a floor, the body and floor form a waste receptacle; and
a blow-molded hollow body having a front wall and a central channel formed in the front wall;
a floor, the body and floor form a waste receptacle;
a lift pocket formed in the central channel;
a lift pocket reinforcement insert molded into the lift pocket.

10. The blow molded waste cart body of claim 9, where in the lift pocket reinforcement comprises:
a main body formed with a longitudinal axis,
an upper face;
a rear face including a generally planar lift contact surface; and
a plurality of retention keys.

11. The blow molded waste cart body of claim 10, wherein the retention keys are spaced along the upper face.

12. The blow molded waste cart body of claim 10, wherein a plurality of retention keys is formed on the rear face.

13. The blow molded waste cart body of claim 10, wherein the retention keys are undercut.

14. The blow-molded waste cart body of claim 9, wherein the lift pocket reinforcement is blow-molded.

15. The blow-molded waste cart body of claim 9, wherein the retention key has a generally trapezoidal top surface.

16. The blow-molded waste cart body of claim 15, wherein the retention key is a section of a trapezoidal cone.

17. A method of forming a waste cart body a blow molding process; comprising the steps of:
melting a polymer material;
forming the polymer material into a parison;
enclosing the parison in a mold the mold having a front wall and a central channel formed in the front wall, the central channel having opposed sidewalls; and
insert molding a reinforcement at the top of the central channel.

18. The method of forming a waste cart body a blow molding process of claim 17; wherein the reinforcement is blow molded prior to formation of the waste cart and comprises:
a main body formed with a longitudinal axis,
an upper face;
a rear face including a generally planar lift contact surface; and
a plurality of retention keys.

19. The method of forming a waste cart body a blow molding process of claim 17, wherein the reinforcement is placed on a shelf in the mold prior to enclosing the parison with the mold.
